(19) United States
(12) Patent Application Publication
(10) Pub. No.: US 2007/0057000 A1
(43) Pub. Date: Mar. 15, 2007

(54) Vehicle carried snowboard rack

(76) Inventor: Ryan L. Webster, Knoxville, TN (US)

Correspondence Address: PITTS AND BRITTIAN P C, P O BOX 51295, KNOXVILLE, TN, 37950-1295, US

(21) Appl. No.: 11/224,180

(22) Filed: Sep. 12, 2005

(51) Int. Cl. B60R 11/00; B60R 9/00

(52) U.S. Cl. 224/521; 224/531; 224/534; 224/917.5

(57) ABSTRACT

An apparatus for carrying snowboards or other recreational equipment at the outside rear of a vehicle. The carrier includes at least one pair of supports with two pairs of slots. Each pair of adjacent slots hold two snowboards inserted bottom-to-bottom into the slots. The two pairs of adjacent slots are separated by a wide slot. The inside pair of snowboards are inserted such that the bindings face each other, but are not compressed or squeezed because the boards are separated by the wide slot. The at least one pair of supports are attached to a vertical member that is attached to a box member. The box member is adapted to be inserted into a standard hitch receiver.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a carrier for snowboards. More particularly, this invention pertains to a carrier adapted to carried by a trailer hitch for compactly carrying a plurality of snowboards.

2. Description of the Related Art

Recreational equipment, such as skis and snowboards, are often oversized and have odd shapes that make storing and transporting such equipment difficult. Typically such recreational equipment has to be transported great distances by vehicle to be used at in a recreational area.

Snowboards, although shorter than skis, are much wider, and typically have both ends curved. Also, snowboards have foot bindings attached to one surface, and these binding are susceptible to damage if not properly protected.

The prior art includes various examples of ski and snowboard carriers and racks that attach to vehicles. Examples of prior art racks include U.S. Pat. No. 5,752,638, titled “Combination water ski and wake board rack,” issued to Meeks, on May 19, 1998, which discloses a boat rack 10 with a pair of forks 12. Each fork 12 has three prongs 18, 20, 22 into which the recreational equipment is inserted. Each fork 12 has an integral strap 48 for securing the recreational equipment supported by the forks 12.

U.S. Pat. No. 5,906,304, titled “Water sport equipment rack.” issued to Baldacchino on May 25, 1999, discloses a water sport equipment rack with two rigid planar members 10. The member 10 has parallel slots 20, 21, 22 for holding water skis and wake boards, a rounded slot 30 for holding a tow rope, and a tapered slot 40 for holding a ski boom. The member 10 is attached to an inboard side wall panel W of the Boat B by a clamp 50.

U.S. Pat. No. 6,019,265, titled “Snowboard rack for pickup trucks,” issued to Deloza on Feb. 1, 2000, discloses a snowboard rack 30 that is carried within a bed 14 of a pickup truck 10. The rack 30 includes a pair of cradles 41 for supporting a snowboard. Each cradle 41 includes a pair of vertical supports 43 with a strap 47 between the supports 43 for securing the snowboard.

U.S. Pat. No. D337,980, titled “Snowboard carrier for attachment to a vehicle roof rack,” issued to Ng on Aug. 3, 1993, is a design patent for a snowboard carrier. The carrier has a pair of slots with an integral strap extending over the slot openings.

United States Patent Application No. 2004/0211800, titled “Car top ski/snowboard carriers,” invented by Johnston and published on Oct. 28, 2004, discloses an automobile roof top carrier 10 for transporting and storing recreational equipment, such as skis and snowboards. The carrier 10 is formed of blocks of soft, resilient material such as mini-cell high-density foam. In one disclosed embodiment, the carrier 10 includes slots 24, 40 into which the recreational equipment are inserted and secured.

Various patents have been issued for racks attached to a vehicle hitch. For example, U.S. Pat. No. 6,695,185, titled “Vehicle equipment rack.” issued to Church on Feb. 24, 2004, discloses an equipment rack 10 of rigid steel in the shape, as seen from the side, of a question mark. The rack 10 includes a vehicle hitch member 30 that is secured to a lower post 28. Although the patent discloses the rack 10 is usable for carrying snowboards, the patent discloses only the structure necessary for carrying bicycles. In particular, the rack 10 includes a tire mount 32 and an attachment assembly 14 for securing a crossbar of a bicycle.

Another example is United States Patent Application No. 2003/0201290, titled “Angled ski rack attachment for a sports rack,” invented by Clausen and published on Oct. 30, 2003. This application discloses a rack assembly 100 with a square post 122 for mating with a receiver of a vehicle hitch 92. The rack assembly 100 carries two skis 94 that have one end passing through a lower retaining member 180 and the other end clamped by an upper retaining member 160, with the skis 94 oriented obliquely to a horizontal plane.

It is an object of the present invention to provide a rack for mounting outside a vehicle for carrying snowboards and the like. It is desirable for such a rack to maximize the storage density of the snowboards. Further, it is desirable to have the rack mounted so as not to occupy available storage space in the vehicle.

### BRIEF SUMMARY OF THE INVENTION

According to one embodiment of the present invention, a snowboard carrier is provided. The carrier is adapted to be carried in a trailer hitch receiver attached to a vehicle. The carrier has a pair of supports for holding four snowboards. The supports have two pairs of adjacent slots into which two snowboards are inserted bottom-to-bottom into each pair of slots. The pairs of slots are separated by a larger slot that separates the two inner snowboards such that the bindings are not compressed or squeezed between the boards. Another embodiment provides for multiple pairs of supports stacked vertically.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of one embodiment of the board carrier;

FIG. 2 is a side view of the board carrier of FIG. 1;

FIG. 3 is an front view of the board carrier of FIG. 1; and

FIG. 4 is a perspective view of one embodiment of the board carrier attached to a vehicle.

### DETAILED DESCRIPTION OF THE INVENTION

An apparatus for carrying snowboards at the outside rear of a vehicle is disclosed. The carrier 10 is readily carried by a conventional trailer hitch receiver secured to the rear of a vehicle. Although the illustrated embodiment and the discussion below refer to snowboards as the equipment to be secured to the carrier 10, those skilled in the art will recognize that other, similarly shaped objects, such as skies and wakeboards, can be used without departing from the spirit and scope of the present invention. Such equipment shares the common attribute of being flat and substantially planar over a surface that is suitable for inserting in a carrier 10.

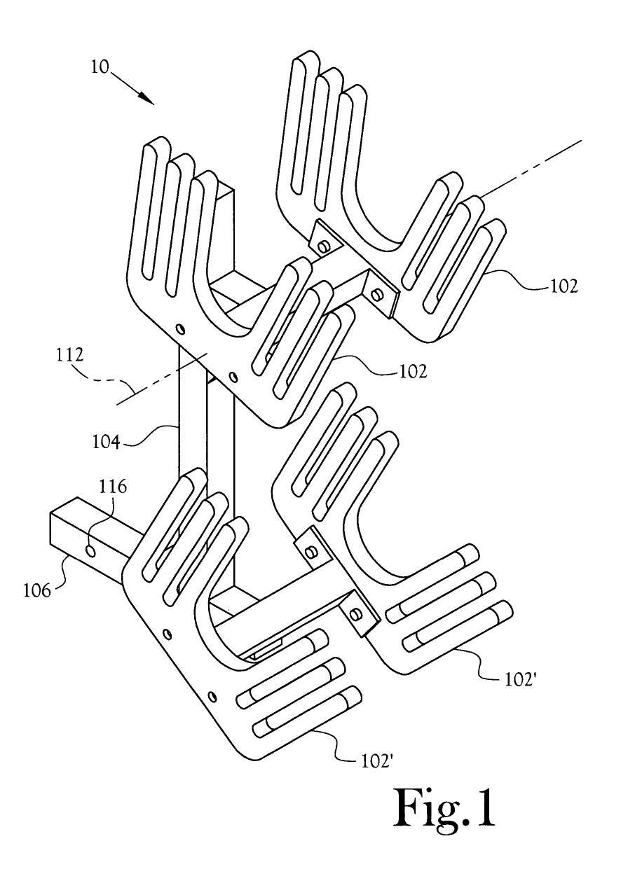

FIG. 1 illustrates a perspective view of one embodiment of the board carrier 10. The carrier 10 includes a pair of upper supports 102 and a pair of lower supports 102′, both of which are supported by a support frame that includes a vertical member 104 and a box member 106.

The vertical member 104 is attached to a box member 106 that fits into a hitch receiver 412 mounted on a vehicle 402. In the illustrated embodiment, the vertical member 104 and the box member 106 are made of lengths of square metal tube welded or otherwise attached to each other. The box member 106 has a through-hole 116 in the side for receiving a hitch pin (not illustrated). In other embodiments, the support frame includes members adapted to support one or more of the pairs of supports 102, 102′. For example, in one embodiment the support frame includes a tubular member bent into an appropriate shape to attach to the vehicle 402, either by bolting or attaching to a hitch 412, and for holding the pairs of supports 102, 102′. In another embodiment, the vertical member 104 is adapted to attach to a vehicle hitch directly, such as by being bolted to the hitch in a similar manner as a hitch ball is attached to a hitch.

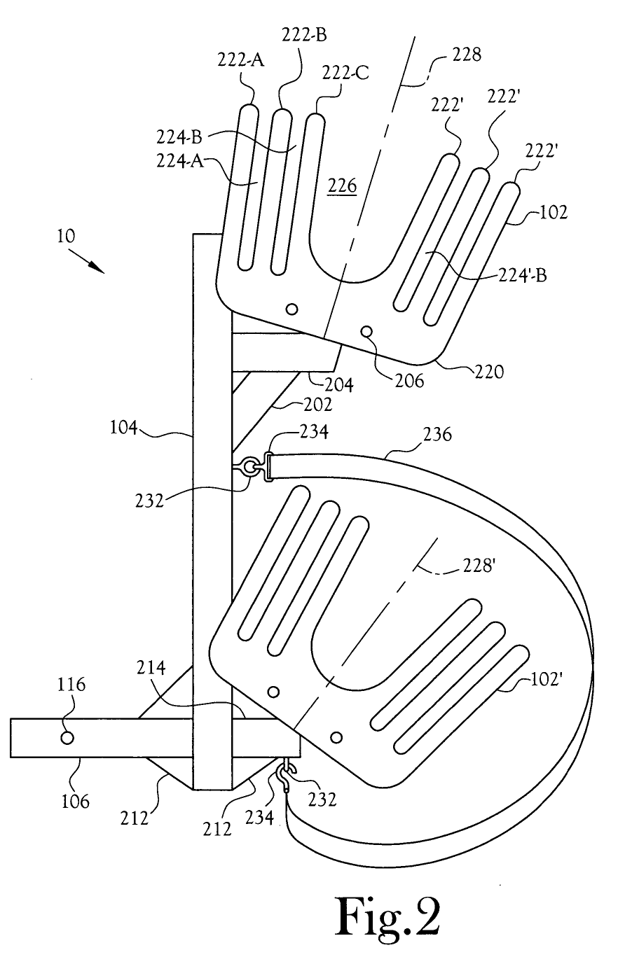

FIG. 2 illustrates a side view of the board carrier 10 of FIG. 1. The upper and lower supports 102, 102′ are adapted to carry four snowboards 404 in a minimum of space. The following discussion is directed toward the upper supports 102, but is equally applicable to the lower supports 102′ and, in other embodiments, any number of supports. Additionally, the illustrated embodiment shows the upper and lower supports 102, 102′ offset vertically, although in other embodiments, the upper and lower supports 102, 102′ are offset vertically and/or horizontally such that each pair of supports 102, 102′ independently carry boards 404.

The upper supports 102 have a base portion 220 at the lower end of each support 102. Extending from the base portion 220 of the upper supports 102 are two sets of prongs 222-A, 222-B, 222-C, 222′-A, 222′-B, 222′-C separated by a wide slot, or gap, 226. The prongs 222 in each set of prongs 222, 222′ define a pair of narrow slots 224-A, 224-B appropriately sized to receive a snowboard 404 between adjacent ones of the prongs 222. With a first snowboard 404 inserted in slot 224-A with its bottom facing the adjacent slot 224B, and a second snowboard 404′ inserted in slot 224-B with its bottom facing the adjacent, first snowboard 404, the bindings and surfaces of each snowboard 404, 404′ are separated and protected. With a third snowboard 404 inserted into the inside slot 224′-B of the second set of prongs 222′ and with its bindings facing the wide slot 226, the bindings of the snowboards 404′, 404 in the two inside slots 224-B, 224′-B are kept at a distance such that the bindings are not compressed or squeezed by the adjacent snowboard 404′, 404.

In the illustrated embodiment, the supports 102 have a center-line 228 about which the supports 102 are symmetrical. The center-line 228 bisects the wide slot 226. In the illustrated embodiment, the center-line 228 of the upper supports 102 is more vertical than the center-line 228′ of the lower supports 102′. Such an arrangement allows the snowboards 404 to be easily inserted and removed from the slots 224 of the lower supports 102′.

In the illustrated embodiment, a strap 236 is illustrated in a position to secure any boards 404 carried by the lower supports 102′. The strap 236 is attached to a pair of hooks 234 that each engage an eyelet 232 secured to the support frame 104, 214. In the illustrated embodiment, the strap 236 is a flexible, stretchable, elastic cord that is in tension when the hooks 234 engage the eyelets 232. In other embodiments, the strap 236 is a flexible cord or other material that is attached to fixed points on the support frame and/or the supports 102′ and includes hardware for adjusting the tension of the strap 236, for example, a ratchet mechanism. In another embodiment, the strap 236 is an elastic cord that is wrapped around the boards 404 and a support frame member and/or support 102, 102′, thereby securing the boards 404 to the carrier 10. Although only one strap 236 is illustrated in FIG. 2, it is understood, in various embodiments, that more than one strap 236 is used and that straps 236 are used with both supports 102, 102′.

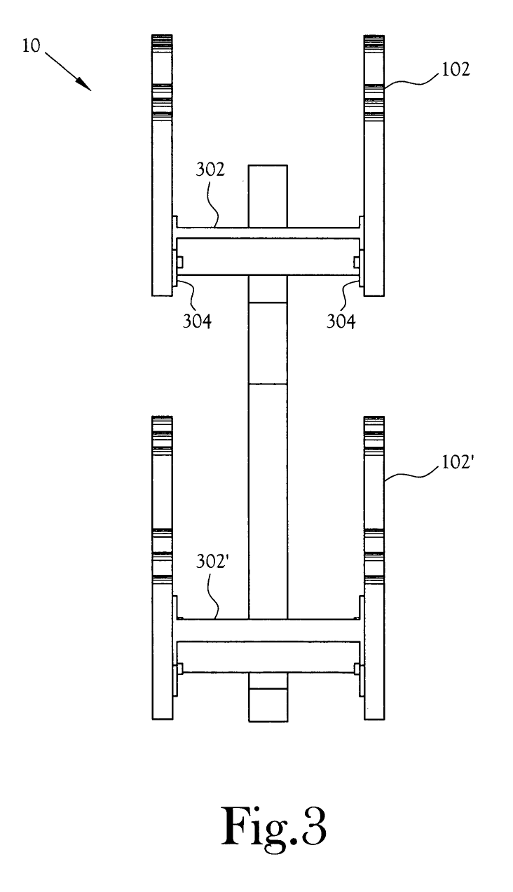

FIG. 3 illustrates a front view of the board carrier 10 of FIG. 1 showing the upper and lower supports 102, 102′. The pairs of supports 102, 102′ are spaced apart by a cross-member 302, 302′. In one embodiment, end plates 304 are welded to the ends of the cross-member 302 and each support 102 is secured to a respective plate 304 by bolts 206.

The cross-member 302 for the upper support 102 is attached to a horizontal member 204 attached to the vertical member 104. The horizontal member 204 is further supported by a diagonal member 202. The lower support 102′ is likewise secured to the vertical member 104. The cross-member 302′ is secured to a second horizontal member 214 attached to the vertical member 104. The horizontal member 204′ is further supported by a diagonal member 212, as is the box member 106. In one embodiment, the box member 106, the vertical member 104, and the associated horizontal members 204, 214 and diagonal members 202, 212, and the cross-members 302 are welded to form a single unit. In other embodiments, the various members are held in fixed relation by bolting, bending, or other techniques for forming structural frames.

The pairs of support members 102, 102′ are each aligned along an axis 112 such that the slots 224, 226 are aligned between the two support members 102, 102′ of each pair. The axis 112, illustrated in FIG. 1, passes through the center of the cross-member 302 connecting the support members 102. As seen from the side (and as illustrated in FIG. 2), the slots 224, 226 are aligned such that the slots 224, 226 receive and hold a board 404 in any of the narrow slots 224 with a longitudinal axis of the board 404 parallel with the support axis 112.

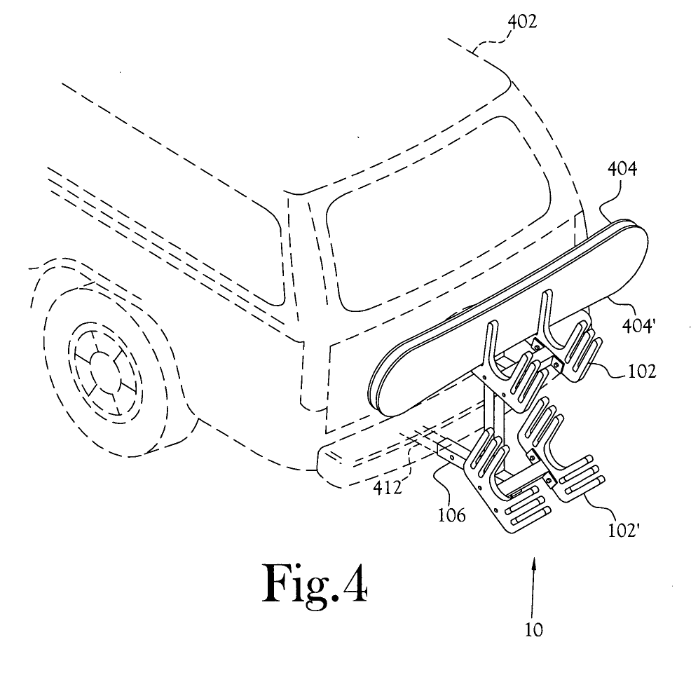

FIG. 4 illustrates a perspective view of one embodiment of the board carrier 10 attached to a vehicle 402. The box member 106 is inserted into the hitch receiver 412 that is attached to the rear of the vehicle 402. Two snowboards 404, 404′ are being carried by the upper support 102 of the board carrier 10. The snowboards 404. 404′ are each inserted in a narrow slot 224-A, 224-B with their bottom surfaces facing each other. In this manner the snowboards 404, 404′ have their surfaces and bindings protected from contacting each other.

The board carrier 10 includes various functions. The function of attaching the support frame 104 to a vehicle 404 is implemented, in one embodiment, by the box member 106. In another embodiment, the function of attaching the vertical member 104 to a vehicle 404 is implemented by fastening the vertical member 104 to a vehicle hitch, such as by bolting the support frame in the same manner as a hitch ball is fastened to the hitch.

The function of holding two pairs of planar objects, such as snowboards 404, in said first pair of support members 102, is implemented, in one embodiment, by the narrow slots 224 between the prongs 224.

The function of separating said two pairs of planar objects, such as snowboards 404, is implemented, in one embodiment, by the wide slot, or gap, 226 between the two sets of prongs 222, 222′.

The function of supporting said first pair of support members 102 is implemented, in one embodiment, by the vertical member 104, the associated members 202, 204, 212, 214, and the cross-members 302, 302′.

The function of securing said two pairs of planar objects, such as snowboards 404, to the first or second pair of support members 102, 102′ is implemented, in one embodiment, by the strap 236 adapted to extend around a portion of the boards 404.

From the foregoing description, it will be recognized by those skilled in the art that a board carrier 10 has been provided. The board carrier 10 includes a pair of support 102 each having a base portion 220 with prongs 222 extending upwardly. The prongs 222 define narrow slots 224 into which the boards 404 are inserted. Between the two sets of prongs 222, 222′ is a wide slot, or gap, 236 that provides space for the bindings of the boards 404 to fit without being compressed, squeezed, or otherwise subject to undue force or damage. In various embodiments, one or more pairs of supports 102 are attached to a support frame that is adapted to be mounted to a vehicle. In the embodiments with more than one pair of support members 102, 102′, the pairs of support members 102, 102′ are positioned on the support frame such that inserting, storing, and removing the boards 404 from any of the slots 222 is unimpeded by the other pair of support members 102, 102′.

The carrier 10 includes a strap 236 for securing one or more boards 404 to the carrier 10. In various embodiments, the strap 236 is either elastic or non-elastic flexible cord or strap that attaches either to itself or to eyelets or other connection points on the carrier 10.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A carrier for transporting and storing recreational boards such as snowboards, said carrier comprising:
a first support member having two sets of three prongs, each one of said two sets of three prongs defining two narrow slots, said two sets of three prongs defining a wide slot between each one of said two sets of three prongs;
a second support member having two sets of three prongs, each one of said two sets of three prongs defining two narrow slots, said two sets of three prongs defining a wide slot between each one of said two sets of three prongs, said second support member positioned substantially parallel to said first support member and aligned with said first support member whereby said first and second support members are adapted to carry a planar object in one of said two narrow slots;
a support member fixing said first support member and said second support member in a spatial relationship; and
a box member adapted to mate with a hitch attached to a vehicle.

2. The carrier of claim 1 further including a strap for securing said planar object in at least one of said two narrow slots.

3. The carrier of claim 1 further including
a third support member having two sets of three prongs, each one of said two sets of three prongs defining two narrow slots, said two sets of three prongs defining a wide slot between each one of said two sets of three prongs; and
a fourth support member having two sets of three prongs, each one of said two sets of three prongs defining two narrow slots, said two sets of three prongs defining a wide slot between each one of said two sets of three prongs, said fourth support member positioned substantially parallel to said third support member and aligned with said third support member whereby said third and fourth support members are adapted to carry a planar object in one of said two narrow slots, said third support member and said fourth support member attached to said support member with said first and second support members offset from said third and fourth support members.

4. The carrier of claim 1 wherein said planar object is selected from a group including a snowboard, a wakeboard, and a ski.

5. A carrier for transporting and storing recreational boards such as snowboards, said carrier comprising:
a first pair of support members including a first support member and a second support member, said first support member substantially parallel to said second support member, each one of said first pair of support members having a base portion and a first set of prongs including
a first prong extending from said base portion;
a second prong extending from said base portion, said second prong substantially parallel to said first prong, said first prong and said second prong defining a first slot; and
a third prong extending from said base portion, said third prong substantially parallel to said second prong, said second prong and said third prong defining a second slot; whereby said first slot and said second slot are adapted to receive a planar object; and
a support frame for carrying said pair of support members, said support frame including a means for attaching said support frame to a vehicle.

6. The carrier of claim 5 further including a strap for securing said planar object in at least one of said first and second slots.

7. The carrier of claim 5 wherein said means for attaching said support frame includes a box member adapted to attach to a hitch.

8. The carrier of claim 5 wherein said planar object is selected from a group including a snowboard, a wakeboard, and a ski.

9. The carrier of claim 5 further including a second pair of support members offset from said first pair of support members, each one of said second pair of support members including a third set of prongs defining at least one narrow slot.

10. The carrier of claim 5 wherein each one of said first pair of support members has a second set of prongs including
a fourth prong extending from said base portion, said fourth prong separated from said third prong by a gap wider than said second slot;
a fifth prong extending from said base portion, said fifth prong substantially parallel to said fourth prong, said fourth prong and said fifth prong defining a third slot; whereby said third slot is adapted to receive said planar object; and
a sixth prong extending from said base portion, said sixth prong substantially parallel to said fifth prong, said fifth prong and said sixth prong defining a fourth slot; whereby said fourth slot is adapted to receive said planar object.

11. The carrier of claim 10 further including a second pair of support members offset from said first pair of support members, each one of said second pair of support members including a third set of prongs defining at least one narrow slot.

12. A carrier for transporting and storing recreational boards such as snowboards, said carrier comprising:
a first pair of support members;
a means for holding two pairs of planar objects in said first pair of support members,
a means for separating said two pairs of planar objects;
a means for supporting said first pair of support members; and
a means for attaching said means for supporting to a vehicle.

13. The carrier of claim 12 further including
a second pair of support members offset from said first pair of support members,
a means for holding two pairs of planar objects in said second pair of support members,
a means for separating said two pairs of planar objects; and
a means for supporting said second pair of support members.

14. The carrier of claim 12 further including a means for securing said two pairs of planar objects to said first pair of support members.

15. The carrier of claim 12 further including a strap for securing said two pairs of planar objects.

16. The carrier of claim 12 wherein said two pairs of planar objects are selected from a group including a snowboard, a wakeboard, and a ski.
